(19) United States
(12) Patent Application Publication
(10) Pub. No.: US 2017/0344855 A1
(43) Pub. Date: Nov. 30, 2017

(54) METHOD OF PREDICTING TRAFFIC COLLISIONS AND SYSTEM THEREOF

(71) Applicant: AGT INTERNATIONAL GMBH, ZURICH (CH)

(72) Inventors: Rohit MANDE, Griesheim (DE); Markus SCHLATTMANN, Griesheim (DE)

(21) Appl. No.: 15/163,094

(22) Filed: May 24, 2016

(51) Int. Cl. G06K 9/62; G08G 1/0962; G06K 9/46; G08G 1/16; G06K 9/00

(52) U.S. Cl. CPC G06K 9/6267; G08G 1/164; G06K 9/00805; G06K 9/4671; G08G 1/0962

(57) ABSTRACT

Methods and systems for determining the likelihood of a traffic collision between vehicles of different vehicle classes at an intersection are disclosed. Data informative of an intersection model is obtained. A first and second vehicle appearing in image data are classified, their trajectories extracted, and a plurality of references trajectories associated with their respective classes are selected from the intersection model. Conflicting pairs of references trajectories are identified. For each pair, the first vehicle is mapped to a point on the first reference trajectory and the second vehicle is mapped to a point on the second reference trajectory. Data indicative of the likelihood of a collision is generated, and a warning is generated when the generated data satisfy a predetermined criterion.

### TECHNICAL FIELD

The presently disclosed subject matter relates to techniques of predicting traffic collisions and, more particularly, to methods and systems enabling prediction of traffic collisions between vehicles at an intersection.

### BACKGROUND

A large number of traffic accidents between different vehicles occur at intersections. Some of these accidents can be avoided if a collision between two vehicles at a certain intersection can be predicted in advance, in which case a warning can be issued to one or both drivers, who can then change course.

Various different techniques exist for predicting traffic collisions between two vehicles. One particular sub-class of techniques involves utilizing motion pattern analysis to estimate the future positions of two vehicles at a certain intersection, based on observed motion patterns of other vehicles at the same intersection.

Problems of predicting traffic collisions using motion pattern analysis are known in the art, and various techniques have been developed to provide solutions. For example,

St-Aubin, P., L. F. Miranda-Moreno, and N. Saunier, “Road User Collision Prediction Using Motion Patterns Applied to Surrogate Safety Analysis”, Transportation Research Board 93^{rd} Annual Meeting, Washington, D.C. (2014), discloses using discretized motion pattern maps for predicting potential collisions between road users by extracting road user trajectory data from video data of a traffic scene.

M. Muffert, D. Pfeiffer and U. Franke, “A stereo-vision based object tracking approach at roundabouts”, IEEE Intell, Transp, Syst, Mag., vol. 5, no. 2, pp. 22-32 (2013), discloses a stereo-vision based system for the recognition of dangerous situations at roundabouts.

K. Minoura and T. Watanabe, “Driving support by estimating vehicle behavior”, 21^{st} International Conference on Pattern Recognition (ICPR), pp. 1144-1147 (2012), discloses predicting vehicle behaviors by using a surveillance camera and an on-board camera and applying a Hidden Markov Model (HMM) to predict straight, right turn, left turn, change to right lane, and change to left lane.

S. Atev, O. Masoud, R. Janardan, and N. Papanikolopoulos, “A collision prediction system for traffic intersections”, Proc. IEEE/RSJ Conf. Intelligent Robots and Systems (IROS) (2005), discloses monitoring traffic intersections in real-time and predicting possible collisions using three-dimensional vehicle size estimation, target localization, false-positive reduction and a collision prediction algorithm using the time-as-axis paradigm.

N. Saunier, T. Sayed and C Lim, “Probabilistic collision prediction for vision-based automated road safety analysis”, Proc. IEEE Int. Conf. Intell. Transp. Syst., pp. 872-878 (2007), discloses computing the collision probability for any two road users in an interaction by processing traffic video data, detecting and tracking the road users, and analyzing their interactions by using motion patterns to predict the road users' movements and determine their probability of being involved in a collision.

N. Saunier and T. Sayed, “Clustering vehicle trajectories with hidden Markov models application to automated traffic safety analysis”, Proc. IJCNN, pp. 4132-4138 (2006), discloses extracting traffic conflicts from video sensor data by clustering vehicle trajectories using a k-means approach with hidden Markov models, and detecting traffic conflicts by identifying and adapting pairs of models of conflicting trajectories.

B. Morris and M. Trivedi, “A survey of vision-based trajectory learning and analysis for surveillance”, IEEE Trans. Circuits Syst. Video Technol., vol. 18, no. 8, pp. 1114-1127 (2008), presents a survey of trajectory-based activity analysis for visual surveillance.

The references cited above teach background information that may be applicable to the presently disclosed subject matter. Therefore the full contents of these publications are incorporated by reference herein where appropriate for appropriate teachings of additional or alternative details, features and/or technical background.

### General Description

The choices of which path to take at a given intersection can sometimes be different for different classes of vehicles. For example, a car approaching a certain intersection may be allowed to turn right, go straight or turn left, whereas a bicycle approaching the intersection from the same direction (and perhaps even the same lane) as the car may only be allowed to turn right or go straight. Given that the paths available to one class might be different than the paths available to another class, better predictions can be made about any particular vehicle's future positions if the class of vehicle and the paths available to the class are known in advance.

However, the collision prediction systems of the prior art typically do not differentiate between different classes of vehicles, such as cars and trucks, or cars and motorcycles, trucks and motorcycles, cars and bicycles, etc. Furthermore, the collision prediction systems of the prior art typically track vehicles using a camera mounted high above the intersection, e.g. to prevent problems of occlusion. From such a high vantage point, these cameras are for the most part unsuitable for detecting and tracking small, narrow objects like bicycles. Yet, accidents between cars and bicycles are some of the most common and serious accidents, as it is relatively easy for a driver of a car to miss noticing a bicycle on the road, and cyclists often sustain very serious injuries after having been hit by a car.

In accordance with certain aspects of the presently disclosed subject matter, there is provided a method of generating an intersection model useable for predicting traffic collisions at a given intersection between vehicles of different classes, the method implemented by a processing unit and comprising, by the processing unit: (a) classifying a vehicle appearing in image data as belonging to a given class out of a predefined set of classes, wherein the image data is informative of a plurality of successive images of vehicles at the intersection; (b) tracking the vehicle to extract the vehicle's trajectory and associating the extracted trajectory with the class of the vehicle; (c) repeating operations (a)-(b) in respect of a plurality of vehicles belonging to different classes to obtain a plurality of extracted trajectories, each associated with a given class out of the predefined set of classes, until a completion criterion is satisfied; (d) for each given class, generating a plurality of reference trajectories associated with the given class and with the given intersection using at least part of the plurality of extracted trajectories associated with the given class, and (e) for each given class, clustering the reference trajectories into one or more clusters, each cluster informative of a path available to be taken by vehicles of the given class at the intersection.

In accordance with certain other aspects of the presently disclosed subject matter, there is provided a system for generating an intersection model useable for predicting traffic collisions at a given intersection between vehicles of different classes, the system comprising a processing unit including at least a processor operatively coupled to a memory, the processing unit configured to: (a) classify a vehicle appearing in image data as belonging to a given class out of a predefined set of classes, wherein the image data is informative of a plurality of successive images of vehicles at the intersection; (b) track the vehicle to extract the vehicle's trajectory and associating the extracted trajectory with the class of the vehicle; (c) repeat operations (a)-(b) in respect of a plurality of vehicles belonging to different classes to obtain a plurality of extracted trajectories, each associated with a given class out of the predefined set of classes, until a completion criterion is satisfied; (d) for each given class, generate a plurality of reference trajectories associated with the given class and with the given intersection using at least part of the plurality of extracted trajectories associated with the given class, and (e) for each given class, cluster the reference trajectories into one or more clusters, each cluster informative of a path available to be taken by vehicles of the given class at the intersection.

In accordance with further aspects of the presently disclosed subject matter, and optionally in combination with other aspects, a data structure can be generated comprising data indicative of all conflicting pairs of reference trajectories, wherein the reference trajectories in a conflicting pair are associated with different classes and wherein a given pair of reference trajectories conflict when the minimal distance between the reference trajectories in the pair is less than a predefined threshold.

In accordance with further aspects of the presently disclosed subject matter, and optionally in combination with other aspects, there can be stored, in the data structure, data informative of one or more pairs of conflicting data points for each pair of conflicting reference trajectories, each one or more pairs of conflicting data points constituted by a first conflicting data point in the first reference trajectory and a second conflicting data point in the second reference trajectory.

In accordance with certain other aspects of the presently disclosed subject matter, there is provided a method of determining the likelihood of a traffic collision between vehicles of different vehicle classes at an intersection, the method implemented by a processing unit and comprising: obtaining data informative of an intersection model associated with the intersection, the intersection model comprising a plurality of reference trajectories associated with each of a plurality of predefined vehicle classes, the intersection model further comprising conflict data informative of conflicting reference trajectories associated with different classes; classifying a first vehicle appearing in image data as belonging to a first class out of the plurality of predefined vehicle classes, and classifying a second vehicle appearing in the image data as belonging to a second class out of the plurality of predefined vehicle classes different from the first class, wherein the image data is informative of a plurality of successive images of vehicles at the intersection; tracking the first and second vehicle using the image data to extract a first trajectory associated with the first vehicle and a second trajectory associated with the second vehicle; selecting, from the plurality of reference trajectories comprised in the intersection model and associated with the first class, a first set of reference trajectories best matching the first trajectory, and selecting, from the plurality of reference trajectories comprised in the intersection model and associated with the second class, a second set of reference trajectories best matching the second trajectory; identifying, using the data indicative of the intersection model, one or more pairs of conflicting reference trajectories, each pair constituted by a first reference trajectory from the first set and a conflicting second reference trajectory from the second set; for each pair of conflicting reference trajectories, mapping the first vehicle to a data point on the first reference trajectory in accordance with the first trajectory, and mapping the second vehicle to a data point on the second reference trajectory in accordance with the second trajectory; generating data indicative of a likelihood of a collision between the first and second vehicle in accordance, at least, with the data points to which the vehicles have been, respectively, mapped; and generating a warning when the generated data satisfy a predetermined criterion.

In accordance with certain other aspects of the presently disclosed subject matter, there is provided a system for determining the likelihood of a traffic collision between vehicles of different vehicle classes at an intersection, the system comprising a processing unit including at least a processor operatively coupled to a memory, the processing unit configured to: obtain from the memory data informative of an intersection model associated with the intersection, the intersection model comprising a plurality of reference trajectories associated with each of a plurality of predefined vehicle classes, the intersection model further comprising conflict data informative of conflicting reference trajectories associated with different classes; classify a first vehicle appearing in image data as belonging to a first class out of the plurality of predefined vehicle classes, and classifying a second vehicle appearing in the image data as belonging to a second class out of the plurality of predefined vehicle classes different from the first class, wherein the image data is informative of a plurality of successive images of vehicles at the intersection; track the first and second vehicle using the image data to extract a first trajectory associated with the first vehicle and a second trajectory associated with the second vehicle; select, from the plurality of reference trajectories comprised in the intersection model and associated with the first class, a first set of reference trajectories best matching the first trajectory, and select, from the plurality of reference trajectories comprised in the intersection model and associated with the second class, a second set of reference trajectories best matching the second trajectory; identify, using the data indicative of the intersection model, one or more pairs of conflicting reference trajectories, each pair constituted by a first reference trajectory from the first set and a conflicting second reference trajectory from the second set; for each pair of conflicting reference trajectories, map the first vehicle to a data point on the first reference trajectory in accordance with the first trajectory, and map the second vehicle to a data point on the second reference trajectory in accordance with the second trajectory; generate data indicative of a likelihood of a collision between the first and second vehicle in accordance, at least, with the data points to which the vehicles have been, respectively, mapped; and generate a warning when the generated data satisfy a predetermined criterion.

In accordance with certain other aspects of the presently disclosed subject matter, there is provided a non-transitory storage medium comprising instructions that when executed by a processing unit comprising at least a processor operatively coupled to a memory, cause the processing unit to: obtain data informative of an intersection model associated with the intersection, the intersection model comprising a plurality of reference trajectories associated with each of a plurality of predefined vehicle classes, the intersection model further comprising conflict data informative of conflicting reference trajectories associated with different classes; classify a first vehicle appearing in image data as belonging to a first class out of the plurality of predefined vehicle classes, and classifying a second vehicle appearing in the image data as belonging to a second class out of the plurality of predefined vehicle classes different from the first class, wherein the image data is informative of a plurality of successive images of vehicles at the intersection; track the first and second vehicle using the image data to extract a first trajectory associated with the first vehicle and a second trajectory associated with the second vehicle; select, from the plurality of reference trajectories comprised in the intersection model and associated with the first class, a first set of reference trajectories best matching the first trajectory, and select, from the plurality of reference trajectories comprised in the intersection model and associated with the second class, a second set of reference trajectories best matching the second trajectory; identify, using the data indicative of the intersection model, one or more pairs of conflicting reference trajectories, each pair constituted by a first reference trajectory from the first set and a conflicting second reference trajectory from the second set; for each pair of conflicting reference trajectories, map the first vehicle to a data point on the first reference trajectory in accordance with the first trajectory, and map the second vehicle to a data point on the second reference trajectory in accordance with the second trajectory; generate data indicative of a likelihood of a collision between the first and second vehicle in accordance, at least, with the data points to which the vehicles have been, respectively, mapped; and generate a warning when the generated data satisfy a predetermined criterion.

In accordance with further aspects of the presently disclosed subject matter, and optionally in combination with other aspects, generating data indicative of a likelihood of a collision between the first and second vehicle in accordance with the data points to which the vehicles have been, respectively mapped can comprise determining, using the intersection model, a first conflicting data point on the first reference trajectory and a second conflicting data point on the second reference trajectory; determining, in accordance with an index of the data point on the first conflicting reference trajectory to which the first vehicle has been mapped and an index number of the first conflicting data point and a frame rate of the image data, a time to arrival of the first vehicle to the first conflicting data point; and determining, in accordance with an index of the data point on the second conflicting reference trajectory to which the second vehicle has been mapped and an index number of the second conflicting data point and a frame rate of the image data, a time to arrival of the second vehicle to the second conflicting data point.

In accordance with further aspects of the presently disclosed subject matter, and optionally in combination with other aspects, each reference trajectory comprised in the intersection model and associated with a given class can further be associated with a given path out of one or more available paths available to be taken by vehicles of the given class through the intersection; and selecting a set of reference trajectories best matching a given vehicle's associated trajectory can comprise determining one or more predicted paths out of the one or more available paths in accordance with the given vehicle's associated trajectory; assigning a matching cost to each reference trajectory associated with each predicted path in accordance with the given vehicle's trajectory; and for each one or more predicted paths, selecting the reference trajectory associated with the predicted path having the lowest matching cost as between all other reference trajectories also associated with the predicted path.

In accordance with further aspects of the presently disclosed subject matter, and optionally in combination with other aspects, the probability can be determined of, for at least one identified pair of reference trajectories, the first vehicle taking the path p associated with the first trajectory and the second vehicle taking the path q associated with the second reference trajectory, and the predetermined criterion can be at least partially met when the probability of the first and second vehicle taking the pair of paths p,q, respectively, is greater than the probability of the first and second vehicles taking a different pair of paths.

In accordance with further aspects of the presently disclosed subject matter, and optionally in combination with other aspects, one of the first and second vehicle can be a car and the other of the first and second vehicle can be a bicycle.

Among advantages of certain embodiments of the presently disclosed subject matter is the ability to separately track different classes of vehicles, and generate warnings when there is a likelihood of collision between vehicles of the different classes. The invention is especially suitable for predicting collisions between cars and bicycles.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates a generalized functional diagram of a collision prediction system in accordance with certain embodiments of the disclosed subject matter;

FIG. 2 illustrates a generalized flow chart of generating an intersection model useable for predicting collisions at a given intersection between vehicles of different classes, in accordance with certain embodiments of the disclosed subject matter;

FIG. 3 illustrates an intersection associated with a plurality of vehicle classes, each class associated with a plurality of reference trajectories in accordance with certain embodiments of the disclosed subject matter;

FIG. 4 illustrates a class's paths, each path having one or more associated reference trajectories in accordance with certain embodiments of the disclosed subject matter;

FIG. 5 illustrates the angle between a vehicle's movement vector and the vertical axis of the image plane in accordance with certain embodiments of the disclosed subject matter;

FIG. 6 illustrates frames of image data in which a vehicle is tracked and its trajectory extracted in accordance with certain embodiments of the disclosed subject matter;

FIG. 7 illustrates a hierarchy of clusters of reference trajectories in accordance with certain embodiments of the disclosed subject matter;

FIG. 8 illustrates a first reference trajectory and a second reference trajectory, each having a number of consecutively indexed data points in accordance with certain embodiments of the disclosed subject matter;

FIG. 9 illustrates a generalized flow chart of determining the likelihood of a traffic collision between vehicles of different vehicle classes at an intersection in accordance with certain embodiments of the disclosed subject matter;

FIG. 10 illustrates a generalized flow chart of selecting a set of best matching reference trajectories for a given vehicle's trajectory in accordance with certain embodiments of the disclosed subject matter;

FIG. 11 illustrates a generalized flow chart of predicting one or more paths for a vehicle of a given class in accordance with certain embodiments of the disclosed subject matter;

FIGS. 12A-12B illustrate a non-limiting example of paths predicted for a vehicle in accordance with certain embodiments of the disclosed subject matter;

FIG. 13 illustrates a pair of conflicting reference trajectories and a collision point therebetween in accordance with certain embodiments of the disclosed subject matter;

FIG. 14 illustrates a generalized flow chart of generating data indicative of a likelihood of collision in accordance with certain embodiments of the disclosed subject matter; and

FIG. 15 illustrates mapping a vehicle to a reference trajectory in accordance with certain embodiments of the disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “classifying”, “associating”, “comparing”, “generating”, “mapping”, “tracking”, “obtaining”, “extracting”, “determining” “selecting” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the processing unit disclosed in the present application.

The terms “non-transitory memory” and “non-transitory storage medium” as used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

The term “criterion” used in this patent specification should be expansively construed to include any compound criterion, including, for example, several criteria and/or their logical combinations.

Embodiments of the presently disclosed subject matter are not described with reference to any particular programming language. It will be appreciated that a variety of programming languages may be used to implement the teachings of the presently disclosed subject matter as described herein.

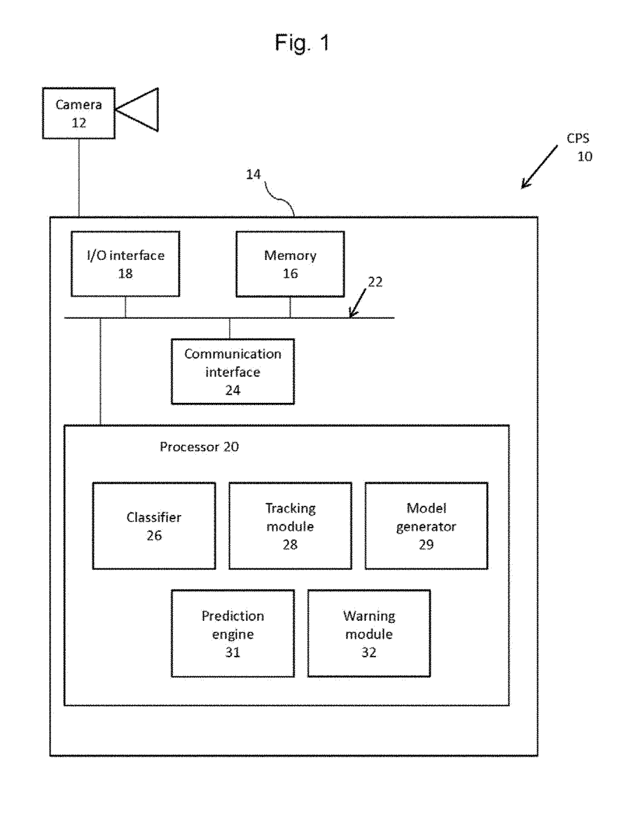

Bearing this in mind, attention is drawn to FIG. 1, where there is illustrated a generalized functional diagram of a Collision Prediction System (CPS) (10), in accordance with certain embodiments of the presently disclosed subject matter. CPS (10) includes a camera (12) operatively coupled to a processing unit (14). As used herein, the term “operatively coupled” should be expansively construed to include all suitable forms of wired and/or wireless connections enabling the transfer of data between coupled components. As used herein, the term “camera” should be expansively construed to include any device suitable for generating image data informative of a vehicle's movement, including e.g. a video camera, or a still camera configured to capture a number of still images in quick succession (e.g. “burst” mode).

In certain embodiments, camera (12) is mounted between 1-5 meters above the ground in close proximity to a given intersection and aimed at the intersection in such a manner so as to generate image data informative of vehicles approaching the intersection (e.g. at least 25 meters before the intersection, or between 30-50 meters before the intersection) and at the intersection. As used herein, the term “intersection” should be expansively construed to cover a section of roadway in which a vehicle can take different routes. Examples of different routes include turning right, turning left, continuing straight, etc. It should be appreciated that a single route can encompass one or several lanes.

In certain embodiments, processing unit (14) includes a memory (16) and a processor (20) operatively coupled e.g. via a communication bus (22). Optionally, processing unit (14) can further include an input/output (I/O) interface (18) and/or a communication interface (24) operatively coupled to the processor and memory, e.g. via communication bus (22). Each interface can comprise (individually or shared with other interfaces) network interface (e.g. Ethernet card), communication port, etc.

Memory (16) can be, e.g., non-volatile computer readable memory, and can be configured to store, inter alia, image data generated by camera (12), data generated by processor (20), and/or program instructions for performing functions related to predicting traffic collision.

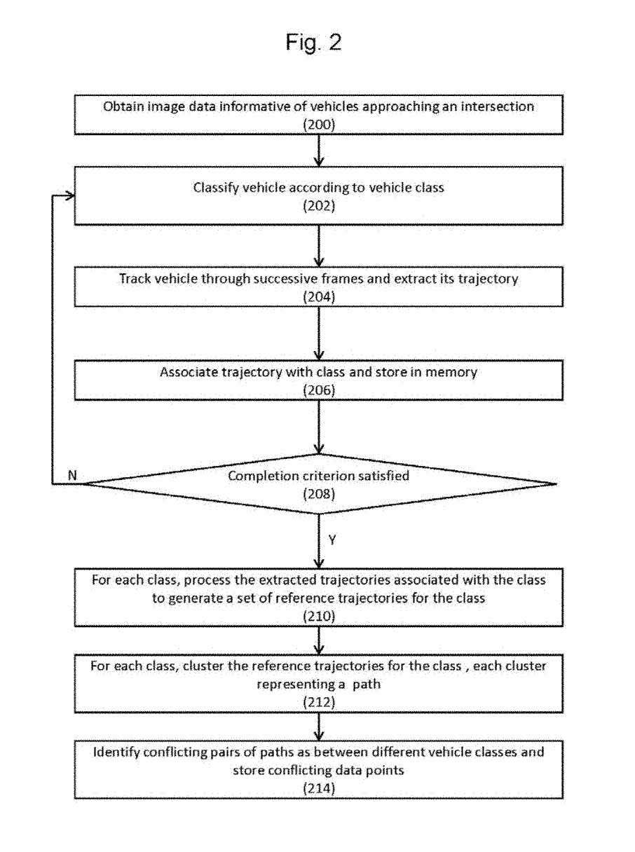

Processor (20) is configured to provide processing necessary for collision prediction analysis as further detailed below in the flowcharts in FIGS. 2, 9-11 and 14.

Processor (20) can be configured to execute several functional modules in accordance with computer-readable instructions stored on a non-transitory computer-readable storage medium. Such functional modules are referred to hereinafter as comprised (or included) in the processor. In certain embodiments, the computer-readable instructions can be stored in memory (16). Processor (20) can include, in certain embodiments, such functional modules as a classifier (26) to detect and classify a vehicle in image data, tracking module (28) to track a vehicle in image data and extract its trajectory, model generator (29) to process extracted trajectories and generate an intersection model, prediction engine (31) to calculate a likelihood of a collision between two tracked vehicles using an intersection model and to generate data indicative of same, and a warning module (32) to generate a collision warning, as will be further detailed with reference to the flowcharts in FIGS. 2, 9-11 and 14.

In certain embodiments, I/O interface (18) can be configured to perform input/output operations related to predicting traffic collisions (including, e.g. receiving user-provided configuration data, and outputting test data for user verification). I/O interface (18) can be connected to at least one input device such as a keyboard (not shown) and/or at least one output device such as a display (not shown).

In certain embodiments, communication interface (24) can be configured to perform send and receive operations related to predicting traffic collisions. For example, using communication interface (24), processing unit (14) can send and receive data to/from other components of CPS which may be physically located external to processing unit (14). For example, camera (12) can be physically located at a certain intersection and configured to send image data to processing unit (14) physically located away from the intersection. Processing unit (14) can perform a collision prediction analysis using processor (20) and send the results of such analysis to a display board located at the intersection, to a computer controlling the intersection (e.g. an intelligent intersection controller in the case that the intersection is an “intelligent” intersection, as that term is used in the art), or to a vehicle approaching the intersection (e.g. in the case that the vehicle is capable of communicating with external computer systems), as will be detailed below with reference to the flowcharts in FIGS. 2, 9-11 and 14.

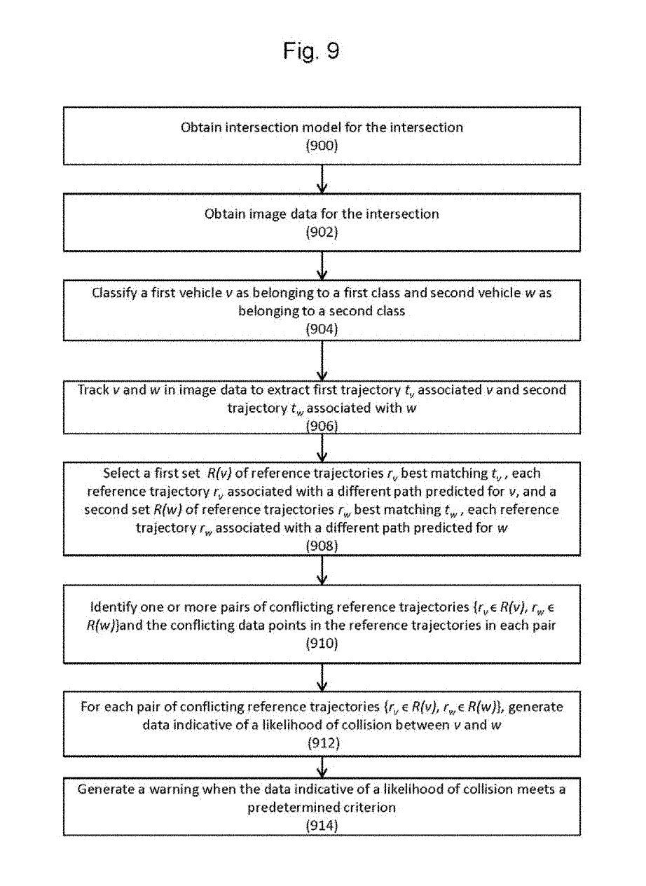

The operation of CPS (10) will now be detailed, in accordance with certain embodiments, with reference to the flowcharts in FIGS. 2, 9-11 and 14. The operation can be divided into two phases. In the first phase, the CPS learns the motion patterns associated with vehicles of different classes approaching the particular intersection, and uses the learned motion patterns to generate an intersection model, as will further be detailed with reference to FIG. 2. In the second phase, the CPS analyzes the motion patterns of vehicles at the same intersection, and uses the intersection model to predict the likelihood of collisions between vehicles, as will further be detailed with reference to FIG. 9.

FIG. 2 illustrates a generalized flow chart of generating an intersection model useable for predicting collisions at a given intersection between vehicles of different classes, in accordance with certain embodiments. Processing unit (14) obtains (200) image data informative of vehicles at an intersection, e.g. from camera (12). As used herein, vehicles “at” an intersection should be understood to include vehicles in the intersection, and vehicles approaching the intersection even though they are not yet in the intersection. The image data can be live and/or pre-recorded. In certain embodiments, the image data which is obtained by the processing unit can be in the form of a video (live and/or recorded) and/or a sequence of still images. In other embodiments, the image data can be data derived from a video and/or a sequence of still images. For purposes of illustration, the following description is made in respect of image data obtained in the form of a video, although it should be appreciated by a person skilled in the art that other forms of image data, such as a series of still images, or data derived from video data or data derived from a series of still images, etc. may also be used.

Processing unit (14), e.g. classifier (26), processes the image data to detect and classify (202) a vehicle appearing in the image data according to the vehicle's class based on a set of predefined classes, e.g. car, truck, bus, motorcycle, etc. In certain embodiments, the set of predefined classes includes car and bicycle. Methods of detecting and classifying objects appearing in images are known in the art. For example, a Support Vector Machine (SVM) can be used to detect and classify the objects after having been trained using Histogram of Oriented Gradients (HOG) feature descriptors extracted from labelled training images. This trained SVM model can be used to classify image regions described using HOG image descriptors. An image “descriptor” refers to a vector of values (e.g. pixel values, gradients, etc.) which describes an image patch. Image “features” refer to a group of one or more pixels in an image which are distinguishable (i.e. are visually distinct in some predetermined respect) from neighboring pixels. Harris corners are an example of image features.

Processing unit (14), e.g. tracking module (28), tracks (204) the classified vehicle through successive frames of the video and extracts data informative of the vehicle's trajectory in the image domain (hereinafter referred to as the vehicle's “trajectory”). The extracted trajectory is associated (206) with the class of the vehicle as previously classified, and stored in memory (16) in association with the class. The process of classifying (202), tracking (204) and associating (206) and storing is repeated in respect of a plurality of different vehicles of different classes until a completion criterion is satisfied (208). The completion criterion can be, e.g. the number of stored trajectories in each of a set of classes meets a predetermined threshold, or the number of tracking hours meets a predetermined threshold, or other criteria. As used herein, a completion “criterion” can be one criterion or several criteria. The completion criterion used should guarantee that upon being met, a sufficient number of stored trajectories (e.g. n≧5) for each class, in the predefined set of classes, exist for each possible route available to vehicles of the class at the intersection. Prior knowledge about the different routes available at the intersection can be used to define the completion criterion however prior knowledge is not necessary. It should be noted that in general, the more stored trajectories that are available to generate the intersection model, the more accurate the prediction is likely to be.

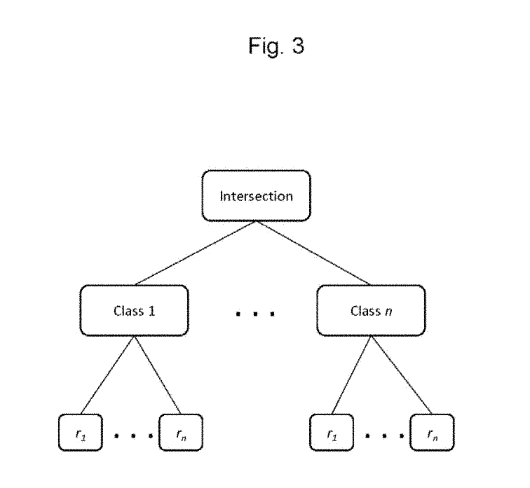

In certain embodiments, upon the completion criterion (208) being satisfied, processing unit (14), e.g. using model generator (29), then processes (210) the trajectories in each class to generate a set of reference trajectories in respect of the class, as will be more fully detailed below. It should be noted that, in certain embodiments, the trajectory processing (210) can, in the alternative, be performed on each trajectory as it is extracted from the image data and prior to all the trajectories having been extracted. In that case, the completion criterion is satisfied, e.g. when a sufficient number of trajectories have been extracted and processed. As a result of processing (210), the intersection is associated with a plurality of vehicle classes, each class associated with a plurality of reference trajectories r. This relationship is illustrated in FIG. 3.

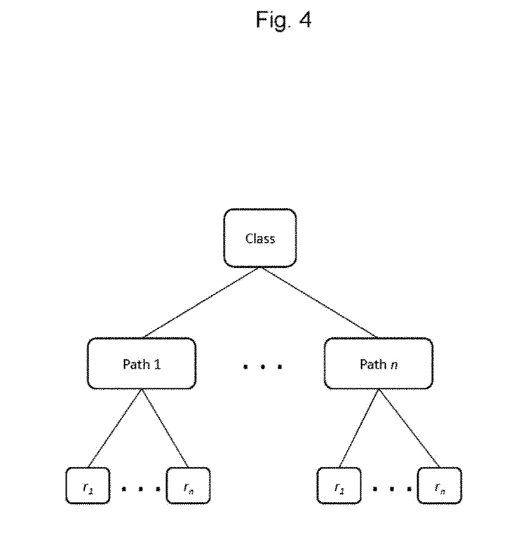

Processing unit (14), e.g. model generator (29), then clusters (212) each class's set of reference trajectories into one or more clusters, each cluster informative of a given path available to vehicles of the class at the intersection thereby learning the available paths, as will be more fully detailed below. As used herein, the term “path” is interchangeably used to refer to a path in its traditional sense (i.e. a route), and also to a cluster of reference trajectories indicative of a route available to a vehicle. As a result of clustering (212), each class's paths are learned, each path having one or more associated reference trajectories r. This relationship is illustrated in FIG. 4.

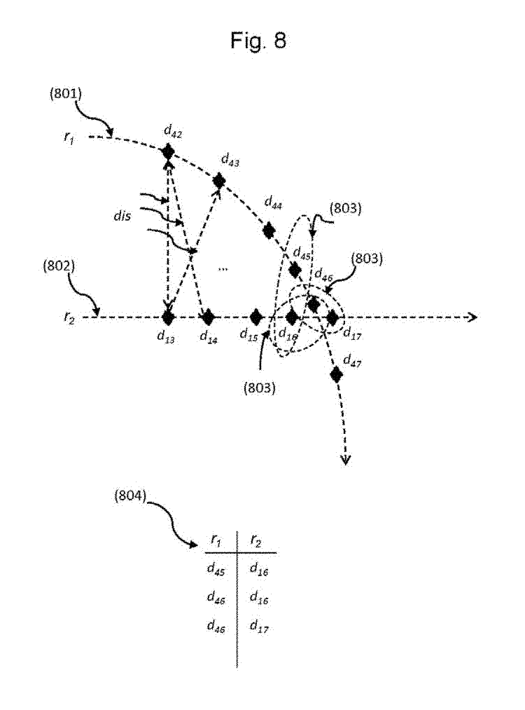

Finally, processing unit (14), e.g. model generator (29), identifies (214) conflicting pairs of paths p, q at the given intersection, where p and q are each associated with different classes (e.g. a car and a bicycle). In certain embodiments, p and q can also be associated with the same class (e.g. two cars). As used herein, a pair of paths p, q conflict when at least one reference trajectory in p conflicts with at least one reference trajectory in q. As will be further detailed below with reference to FIG. 8, two reference trajectories r₁ and r₂ are can be said to conflict when they come within a predefined threshold distance of each other in two dimensional space (i.e. the minimal distance between them is less than the predefined threshold). Conflict data informative of pairs of reference trajectories that conflict, and one or more pairs of conflicting data points on respective trajectories, is stored in a data structure as part of the intersection model.

Tracking (204) a vehicle will now be more fully detailed in accordance with certain embodiments. Methods are known in the art for tracking objects in successive frames of image data and extracting their trajectories. Any suitable method may be used. In certain embodiments, it may be desirable to use a low mounted camera (1-5 meters above the ground) for capturing data. For example, small vehicles like bicycles are more reliably tracked using a low mounted camera close to the intersection. In this case, problems of occlusion of tracked vehicles occur, and therefore the tracking method which is used should be robust enough to handle problems of temporary occlusion (full or partial) of tracked vehicles, and to automatically re-identify the tracked vehicle once the vehicle at least partially re-appears.

One such robust tracking method will now be detailed. This method involves from the outset searching and detecting a large number (e.g. 10<n<40) of Shi-Tomasi corners per vehicle around the center of the vehicle, and tracking these corners using a Lucas-Kanade optical flow method. If a large enough number of corners per vehicle are initially searched and detected then in case of partial occlusion in subsequent frames, at least some of the corners should still remain visible. Assuming that to be the case, the occluded vehicle can then be identified as the same vehicle as a prior tracked vehicle (i.e. in previous frames before the occlusion occurred) by matching the visible corners of the occluded vehicle (e.g. using the spatial position of the corners relative to one another) to a subset of corners of a prior tracked vehicle. Once the visible corners are matched to a specific vehicle, the location of the center point of the vehicle, even if occluded, can be determined by extrapolation based on the matched corners.

In case of full occlusion, no corners will be visible in some frames. However, assuming at least some of the corners re-appear in subsequent frames (due to movement of the occluding object, or the vehicle behind the object, or both) the object can be re-mapped if the object detection module detects the presence of the vehicle (e.g. the classifier detects the same class of vehicle at the same or near location as the occluded object within a threshold time period). In certain embodiments, a fully occluded vehicle is re-mapped to a previously acquired trajectory only in case of short duration occlusions, e.g. 0-2 seconds, in order to minimize the risk of re-mapping to the wrong trajectory (i.e. a trajectory acquired for a different vehicle). In case of full occlusions of longer durations (e.g. more than 2 seconds), tracking can be terminated at the point of the occlusion, and the acquired trajectory up to the point of the occlusion can be added to the database or, alternatively, it can be discarded.

In certain embodiments, the optical flow of corners can be used to detect incorrect tracking caused by occlusion, since it is expected that in such a case the optical flow of the corners will not be uniform and will have high standard deviation. Conversely, in the case of correct tracking with no occlusion, it is expected that all the corners of an object will have exhibit similar optical flow and thus the standard deviation of optical flow of the corners will be low. The standard deviation can also be used to identify occlusions. Upon re-identification, the object's current trajectory can be mapped to its previous trajectory which was extracted prior to the occlusion. In certain embodiments, occlusion detection may only be required at certain points at the intersection which are known in advance and can be input to the system. For example, the area before an intersection where vehicles are required to stop and queue for a traffic signal is one such typical area where there could be occlusion.

During tracking (204), a vehicle's trajectory t is extracted from the image data and recorded as an ordered set of data points d_{0 . . . n}. Typically, a data point is collected for each frame in which the vehicle is tracked, and tracking is normally done in each frame in which the vehicle is visible (at least partially) and detectable by the tracking module. In certain embodiments, each data point d records spatial and kinematic data associated with the vehicle in a given frame. Spatial data can include, e.g. the vehicle's 2D position in the image domain (e.g. the x,y pixel coordinates of the tracked center of vehicle), the vehicle's direction in the image domain (e.g. angle with respect to a predetermined axis). In certain embodiments, a vehicle's kinematic data can include, e.g. speed (e.g. in pixels per frame), acceleration, etc. As such, the trajectory t for a vehicle v can be described as a vector of k dimensions (i.e. elements), such that

tᵥ={d₀, . . . , dₖ}, dᵢ={posᵢ, spdᵢ, accᵢ, θᵢ}

where

posᵢ is the position of v in the i-th frame, e.g. the x,y coordinates of its center point;

spdᵢ is the speed of v in the i-th frame (e.g. calculating in pixels/second as can be derived using the pos data taken from one or more previous frames, etc.);

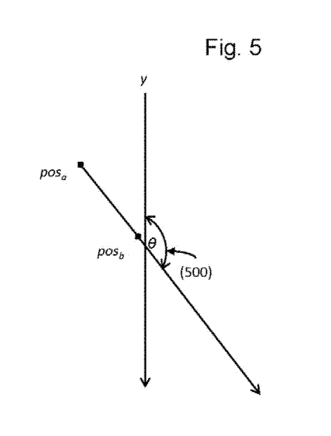

accᵢ is the acceleration of v in the i-th frame (e.g. calculated in pixels/(second)² as can be derived from the spd data taken from one or more previous frames; and
θᵢ is the direction of v in the i-th frame (e.g. calculated as the angle between the vehicle's movement vector {posᵢ₋ₙ, . . . , posᵢ} and the vertical axis of the image plane, as illustrated in FIG. 5 in which angle (500) represents an angle between the vehicle's movement vector and the vertical axis (y) of the image plane.

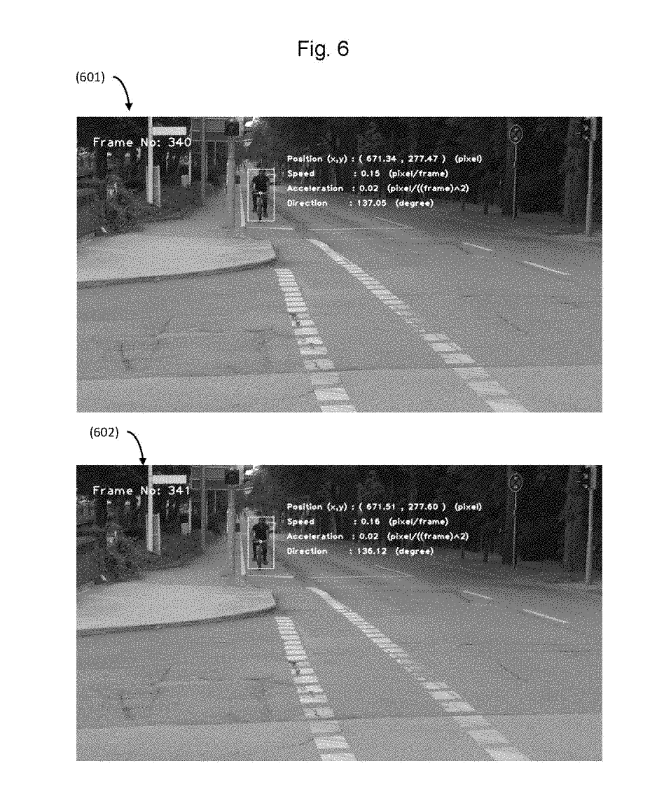

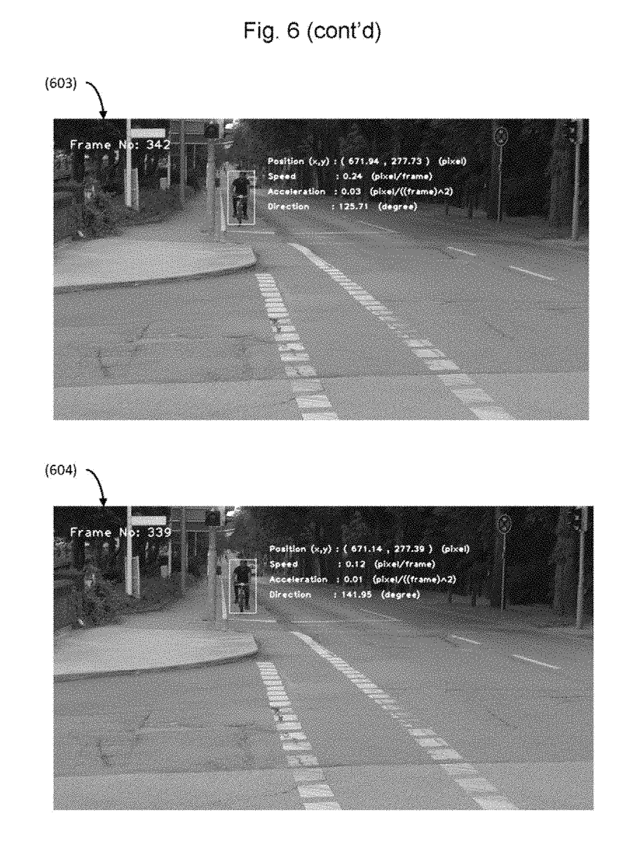

By way of non-limiting example, FIG. 6 illustrates each of four frames (601)-(604) of image data in which a vehicle (in this case a bicycle) is tracked and its trajectory extracted. Using the trajectory data from frames appearing in FIG. 6, the bicycle's trajectory segment associated with these four frames is given by:

t_{bicycle}={((671.34, 277.47), 0.15, 0.02, 137.05),

((671.51, 277.60), 0.16, 0.02, 136.12),

((671.94, 277.73), 0.24, 0.03, 125.71),

((671.14, 277.39), 0.12, 0.1, 141.95)}

Processing (210) extracted trajectories to generate a plurality of reference trajectories will now be further detailed. It should be noted that the reference trajectories for each class are processed separately, though the sets of reference trajectories for different classes may be processed in parallel. First, a data removal process is applied to the extracted trajectories to remove trajectories which do not contribute a sufficient amount of data to be useable in the model. For example, short trajectories (e.g. having length L less than 400 pixels based on a frame resolution of 1920×1080 pixels), and trajectories having fewer than a certain minimum number of data points (e.g. <50) typically do not convey meaningful data and can be discarded. In certain embodiments, the data removal process may alternatively be applied during the tracking (204), in which case only trajectories meeting a minimum length and minimum number of data points are stored. Next, the remaining trajectories which are of different dimensions (i.e. different number of data points) are converted to trajectories having equal dimension data (i.e. same number of data points). Methods of converting variable dimension trajectories to equal dimension trajectories are known in the art. See, e.g. Morris and Trivedi. Briefly, a dimension k is arbitrarily chosen. The inventors have found that k=100 works well.

Next, each trajectory is sampled to extract k equidistant data points along the length L (in pixels) of the trajectory. The length of the trajectory can be calculated as the sum of the pixel distances (horizontal and vertical) between each pair of consecutive data points. First, a step size S is calculated as S=L/k. Next, the trajectory is traversed and data points d at least S pixels apart from one another are selected, beginning with the first data point d₀, until the end of the trajectory is reached. After sampling, the converted trajectory is guaranteed to have k or fewer data points. In the case that the converted trajectory has fewer than k data points, the converted trajectory is resampled and additional data points are added until the number of data points equals k. The additional data points can be derived data points, e.g. derived using linear interpolation, or they can be actual data points which were removed during the sampling process. The converted trajectories are the reference trajectories r.

Clustering (212) a plurality of reference trajectories r associated with a class, thereby learning the paths available to vehicles of the class, will now be more fully detailed. Although a clustering (212) process is detailed herein to learn the available paths, other suitable path learning algorithms as known in the art can also be used. See, e.g. Morris and Trivedi in which a number of path learning techniques are detailed. In certain embodiments, k-means clustering can be used to cluster the plurality of reference trajectories associated with a class into k clusters. While k can be any value, the inventors have found that 5≦k≦20 works well. In addition, since each cluster represents a given path through the intersection, prior knowledge of the number of possible paths through the intersection that are available to be taken by vehicles of the given class can be used to set the value for k.

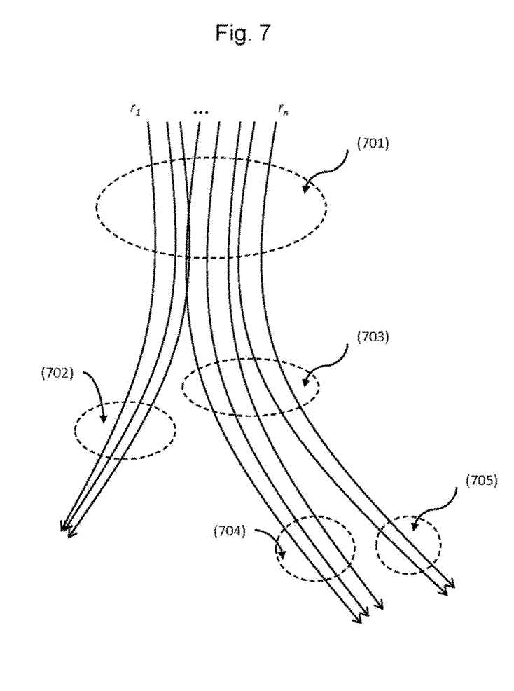

In certain embodiments, the reference trajectories r are clustered according to position data pos. Next, the clusters are grouped in agglomerative hierarchical fashion according to direction at end point (θₖ) and Euclidean distance between cluster centers with respect to the first data point, middle data point, and last data point (the cluster centers being a trajectory (either actual or derived) which is representative of the cluster). That is, for each cluster center, the shortest distances of its first data point, middle data point, and end data point from any point on each other cluster is calculated. This computation is done for all the clusters of the class. Then for each cluster its end direction is calculated. End direction can be calculated as angle between the vertical axis of the image plane and the imaginary line that would be formed by connecting the n^{th} data point and a prior data point, such as the (0.8 n)^{th} data point of the cluster center, where n is the number of data points on the cluster centre. Then, for any two clusters, if the absolute value of the difference between their respective end directions is less than a threshold, e.g. 30 degrees, then 3 representative distances are calculated for this cluster pair. These representative distances are shortest distance with respect to first data point, middle data point, and end data point. In other words, if the shortest distance between the first data point on the center of cluster 1 to any point on the center of cluster 2 is 50, and the shortest distance between the first data point on the center of cluster 2 to any point on the center of cluster 1 is 20, then the representative distance with respect to the first point for cluster pair 1-2 will be 20. If all three representative distances are less than a threshold, e.g. 30, and, as previously detailed the difference between the end direction of cluster centers is less than a threshold, e.g. 30 degrees, then these two clusters are grouped together. Similar calculations are done for all clusters, and all clusters which fulfil the above-mentioned distance and direction metric are grouped together. Each resulting cluster corresponds to a path available to be taken by a vehicle in the associated class. The hierarchical grouping of clusters represents path divergence. By way of non-limiting example, FIG. 7 conceptually illustrates a hierarchy of five clusters (701)-(705) of reference trajectories representing five diverging paths, each cluster representing a path. In certain embodiments, human knowledge about the intersection and the different paths which are actually available to vehicles can be used to fine-tune the learned set of paths (e.g. by manually discarding “invalid” paths).

In certain embodiments, clustering (212) can alternatively be performed incrementally, that is on each reference trajectory as it is generated and prior to all references trajectories having been generated.

Identifying (214) pairs of conflicting paths through the intersection and recording conflict data in a data structure will now be more fully detailed. As detailed above, a pair of paths p, q conflict when at least one reference trajectory r₁ associated with path p conflicts with at least one reference trajectory r₂ associated with path q. A conflict exists between two reference trajectories when the minimum distance between the trajectories is lower than a threshold (e.g. 10 pixels). The minimum distance is the smallest distance between a point on the first reference trajectory and a point on the second reference trajectory. The minimum distance between two trajectories r₁ and r₂ can be determined by calculating the pixel distance from each point d(₁₋ₙ) in r₁ to each point d₍₁₋ₘ₎ in r₂ for a total of n×m distances, and taking the minimum distance.

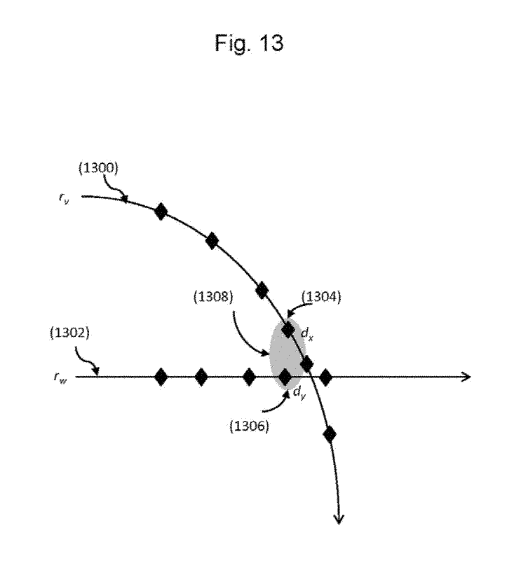

By way of non-limiting example, FIG. 8 illustrates a first reference trajectory r₁ (801) associated with path p and a second reference trajectory r₂ (802) associated with path q, each of r₁ and r₂ having a number of consecutively indexed data points. As illustrated in FIG. 8, the distance dis between trajectories r₁ and r₂ (as measured between respective data points) gets progressively smaller as between d₄₅ of r₁ and d₁₆ of r₂, dis is less than the threshold. Therefore, r₁ and r₂ are conflicting reference trajectories, and d₄₅ of r₁ and d₁₆ of r₂ are conflicting data points. Because r₁ and r₂ conflict, p and q are “conflicting paths”, and the pair of paths p, q are said to “conflict”. The index numbers of conflicting data points (803) on respective reference trajectories are stored (e.g. in memory (16)) in a data structure such as lookup table (804). In certain embodiments only the first pair of conflicting data points is recorded in the data structure. The pair of conflicting data points on respective trajectories define the collision point between the trajectories, as detailed below with reference to FIG. 13.

Referring now to FIG. 9, there is illustrated a generalized flow chart of determining the likelihood of a traffic collision between vehicles of different vehicle classes at an intersection.

Processing unit (14) obtains (900) (e.g. from memory (16)) an intersection model comprising, for the intersection, a plurality of reference trajectories associated with different vehicle classes out of a predefined set of classes, the plurality of reference trajectories associated with a given class grouped into one or paths available to be taken by vehicles of the given class, as detailed above with reference to FIGS. 2 and 7. The intersection model further comprises data informative of all pairs of conflicting reference trajectories associated with different classes, and, for each pair, data informative of at least one pair of conflicting data points, as detailed above with reference to FIGS. 2 and 8.

Processing unit (14) obtains (902) (e.g. from camera (12)) image data informative of vehicles at the intersection. The process of obtaining image data which was detailed above with reference to FIG. 2 is also applicable to FIG. 9, except that the video must be live (i.e. obtained in real-time) in order to predict traffic collisions in advance and in real-time.

Processing unit (14), e.g. using classifier (26), classifies (904) a first vehicle v as belonging to a first class C(v), and a second vehicle w as belonging to a second class C(w), the first and second classes being part of the predefined set of classes used in the obtained intersection model. In certain embodiments, as detailed above, the predefined classes include “car” and “bicycle”, and one of v and w is a car and the other is a bicycle. In certain embodiments, both v and w can also belong to the same class. The process of detecting and classifying vehicles which was detailed above with reference to FIG. 2 is also applicable here.

Processing unit (14), e.g. using tracking module (28), tracks (906) each of v and w in the image data to extract each vehicle's (at least partial) trajectory, thereby extracting a first trajectory tᵥ associated with v, and a second trajectory t_{w} associated with w. The process of tracking a vehicle to extract its trajectory which was detailed above with reference to FIG. 2 is applicable here as well. It should be noted that tracking (906) is performed in real-time so that as each of the first and second vehicle move through the intersection, their respective extracted trajectories “grow” as data points are added. It should further be noted that the most current two-dimensional location of a tracked vehicle is provided by the most recently added data point on the vehicle's extracted trajectory.

Concurrently with tracking (906), processing unit (14) (e.g. using prediction engine (31)) selects (908), in accordance with the tᵥ, a first set R(v) of best matching reference trajectories rᵥ matching tᵥ from amongst the plurality of reference trajectories associated with class C(v) comprised in the intersection model, and a second set R(w) of best matching reference trajectories r_{w} matching t_{w} from amongst the plurality of reference trajectories associated with class C(w) in the intersection model.

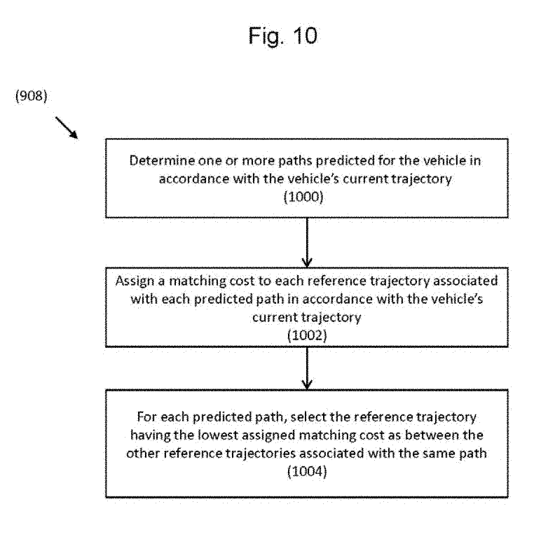

The selected reference trajectories rᵥ in R(v) are each associated with a different path p available to be taken by v, and each reference trajectory r_{w} in R(w) is associated with a different path q available to be taken by w. Each reference trajectory rᵥ in R(v) is further associated with a matching cost indicative of a match between rᵥ and tᵥ, and each reference trajectory r_{w} in R(w) is further associated with a matching cost indicative of a match between r_{w} and t_{w}. The selected reference trajectories rᵥ in R(v) and r_{w} in R(w) are selected on the basis of having been assigned the lowest matching cost as amongst all other reference trajectories associated with same class and the same path, as further detailed below with reference to FIG. 10.

Using the intersection model, processing unit (14) (e.g. prediction engine (31)) identifies (910) one or more pairs of conflicting reference trajectories, a pair constituted by a first reference trajectory rᵥ from the first set R(v) and associated with a path p predicted for v, and a second reference trajectory r_{w} from the second set R(w) and associated with a path q predicted for w and conflicting with the first reference trajectory. Using the intersection model, processing unit (14) also identifies conflicting data points associated with each pair of conflicting reference trajectories. Examples of conflicting data points were detailed above with reference to FIG. 8.

It should be noted that if no pairs of conflicting reference trajectories are identified, there is unlikely to be a collision between v and w, as none of the paths p predicted for v and paths q predicted for w conflict. Therefore, nothing further needs to be done, at least insofar as vehicles v and w are concerned (since it is contemplated that the CPS can concurrently track and perform collision prediction analysis on multiple vehicles and/or pairs of vehicles). On the other hand, the existence of one or more pairs of conflicting reference trajectories rᵥ, r_{w} is indicative of one or more pairs of conflicting paths p, q predicted for v and w, respectively, and therefore there exists a likelihood of a collision.

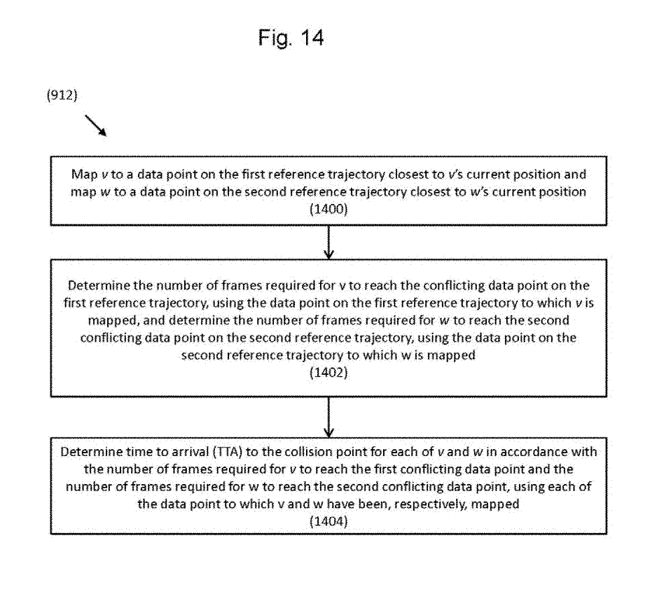

For each pair of conflicting reference trajectories rᵥ, r_{w}, processing unit (14) (e.g. prediction engine (31)) generates data (912) indicative of a likelihood of collision between v and w, as will be detailed below with reference to FIG. 14. For example, the data can be indicative of a time to arrival (TTA) of v and/or w to the collision point (and/or a difference in their respective TTAs), where the collision point may be broadly defined as the area in the two-dimensional image domain located substantially between the pair of conflicting data points (inclusive of the points themselves). By way of non-limiting example, FIG. 13 illustrates a pair of conflicting reference trajectories rᵥ (1300) and r_{w} (1302). Data point dₓ (1304) on rᵥ (1300) conflicts with data point d_{y} (1306) on r_{w} (1302). The shaded area (1308) between dₓ (1304) and d_{y} (1306) corresponds to the collision point.

Referring now to FIG. 14, there is illustrated a generalized flow chart of determining a TTA of a first vehicle v and a second vehicle w to a collision point, the collision point being defined with respect to a first conflicting data point on a first reference trajectory corresponding to v and a second conflicting data point on a second reference trajectory corresponding to w and conflicting with the first reference trajectory. First, processing unit (14) maps (1400) v to a data point on the reference trajectory and maps w to a data point on the second reference trajectory. In each case, the data point which the vehicle is mapped to is chosen on the basis of being the closest in two-dimensional space to the data point on the vehicle's actual trajectory which is indicative of the vehicle's current position (i.e. the last point). Next, processing unit (14) determines (1402), for v, the number of frames (e.g. using the indexes of the data points on the first reference trajectory) required for v to reach the collision point (e.g. by subtracting the index of the conflicting data point on the first reference trajectory by the index of the data point on the first reference trajectory that v was mapped to. Likewise, processing unit (14) further determines, for w, the number of frames (e.g. using the indexes of the data points on the second reference trajectory) required for w to reach the collision point (e.g. by subtracting the index of the conflicting data point on the second reference trajectory by the index of the data point on the second reference trajectory that w was mapped to. Finally, processing unit (14) determines (1404) the TTA of each of v and w to the collision point by converting the number of frames required for each of v and w, respectively, to reach the collision point into seconds, e.g. by dividing the number of frames with the frame rate of the image data in seconds.

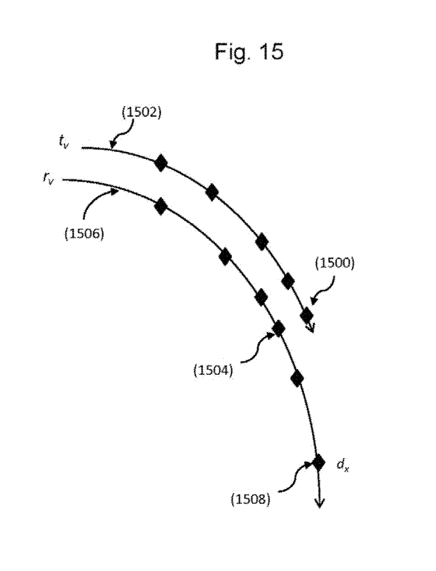

By way of non-limiting example, FIG. 15 illustrates v's current position (1500) on tᵥ (1502). Data point (1504) on rᵥ (1506) is the closest (in two-dimensional space) data point on rᵥ (1506) to (1500) and is therefore selected as a reference data point for mapping v to rᵥ (1506). In FIG. 15, v mapped to (1504) is two data points away from the collision point indicated as conflicting data point dₓ (1508). Therefore, v is likely to reach the collision point in two frames. Dividing by the number of frames per second provides v's TTA to the collision point in seconds.

In certain embodiments, the generated data can include data indicative of the likelihood of v and w taking conflicting paths p and q, respectively, where p is the path associated with reference trajectory rᵥ and q is the path associated with reference trajectory r_{w}, as will further be detailed below.

Finally, processing unit (14) (e.g. warning module (32)) generates (914) a warning when the data indicative of a likelihood of collision meets a predetermined criterion, as will be further detailed below. In certain embodiments, the generated warning can be displayed (e.g. using I/O interface (18)) on a display screen mounted at the intersection and visible to at least one of v's operator and w's operator. In certain embodiments, the generated warning can be wirelessly transmitted (e.g. using communication interface (24)) to one or both of v and w for display in the vehicle using the vehicle's on-board electronics system, where the vehicle is operable to receive incoming messages from computer systems external to the vehicle (e.g. vehicles operable to receive vehicle-to-vehicle communications (V2V/V2X) messages).

In certain embodiments, the generated warning can be one of a high severity warning and a low severity warning. A high severity warning can be generated when a first predetermined criterion is met, and a low severity warning can be generated when a second predetermined criterion is met. In certain embodiments, the high severity warning can include red, flashing text warning of an imminent collision. In certain embodiments, the low severity warning can include steady, amber text warning of a possible pending collision.

By way of non-limiting example, the first predetermined criterion (for generating a high severity warning) can be met when, e.g.:

1) The likelihood of v and w taking conflicting paths is greater than 0.55 (55%); and

2) At least one of v or w will reach the point of collision in the next 3 seconds or less; and

3) v and w will reach the point of collision less than 2 seconds apart from one another.

The second predetermined criterion (for generating a low severity warning) can be met one, e.g. two of three (but not all three) of the first predetermined criterion above (for generating a high severity warning). By way of non-limiting example, the second predetermined criterion (for generating a low severity warning) can be met when, e.g.:

1) The likelihood of v and w taking a pair of conflicting paths is greater than the likelihood of v and w taking another (non-conflicting) pair of paths; and

2) At least one of v or w will reach the point of collision in the next 3 seconds or less; and

3) v and w will reach the point of collision more than 2 seconds but less than 5 seconds apart from one another;

By way of a second non-limiting example, the second predetermined criterion (for generating a low severity warning) can be met when, e.g.:

1) The likelihood of v and w taking conflicting paths is less than the likelihood of v and w taking another (non-conflicting) pair of paths; and

2) At least one of v or w will reach the point of collision in the next 3 seconds or less; and 3) v and w will reach the point of collision less than 2 seconds apart from one another.

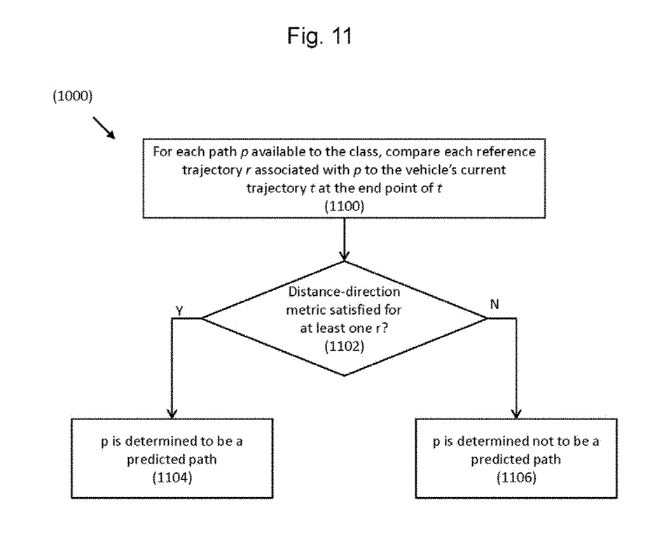

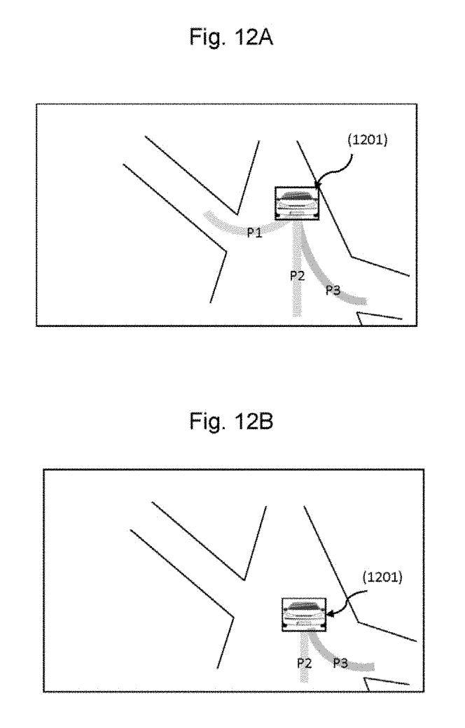

Referring now to FIG. 10, there is provided a generalized flow chart of selecting a set of best matching reference trajectories for a given vehicle's trajectory t, each selected reference trajectory r associated with a different path, in accordance with certain embodiments. Using the intersection model, processing unit (14) determines (1000) one or more paths predicted for the vehicle in accordance with the vehicle's trajectory t, as will be further detailed below with reference to FIG. 11. In some cases, depending on where the vehicle is in the intersection and the direction it is pointed, the paths predicted for the vehicle are all the paths available for vehicles of the class, while in other cases only a subset of paths which are available to the class are actually predicted for the vehicle. By way of non-limiting example, FIGS. 12A-12B conceptually illustrate a non-limiting example of paths predicted for a vehicle. In FIG. 12A, vehicle (1201) has not yet entered the intersection. The paths predicted for vehicle (1201) are shown as paths P1, P2 and P3 and together represent the totality of all paths through the intersection available to vehicles of the same class as vehicle (1201). FIG. 12B shows the paths available to vehicle (1201) approximately two seconds later, once vehicle's (1201) position and direction have changed with respect to FIG. 12A, as vehicle (1201) is at a more advanced stage of progression through the intersection. At this point, path P1 is no longer predicted for vehicle (1201), there remaining only predicted paths P2 and P3.

Returning now to FIG. 10, after having determined the vehicle's one or more predicted paths, processing unit (14) assigns (1002) a matching cost to each reference trajectory associated with each predicted path in accordance with the vehicle's current trajectory, as will further be detailed below. Finally, processing unit selects (1004), for each predicted path, the reference trajectory r having the lowest assigned matching cost as between the other reference trajectories associated with the same path, thereby selecting a set of best matching reference trajectories r for a vehicle in accordance with its current trajectory t, the set of best matching reference trajectories associated with a respective set of predicted paths wherein each reference trajectory in the set is associated with a different predicted path.

As detailed above, a matching cost is assigned to each reference trajectory r associated with a predicted path p in accordance with r's dissimilarity to t. The matching cost assigned to a given reference trajectory r can be calculated as the sum of the pair-wise distances between the last of n data points of r and the last n data points of t, where the n data points on t represents a portion of the vehicle's current trajectory before its current position, and the n data points on r represent a corresponding portion of r before the data point on r having the least two-dimensional distance to the last data point on t. The trajectory portions used to calculate the matching cost should have the same length (i.e. same number n of data points), for example 1-20 data points. If more than one data point on each trajectory is compared, the pair-wise distance of each pair of corresponding data points can be multiplied by Gaussian weights such that the calculated matching cost is biased in favour of data points closest to the vehicle's current position (since vehicle behaviour at its current position is a better predictor of future positions than its behaviour at previous positions). Each pair-wise distance can be calculated as the sum of distances of each element position, direction, speed and acceleration.

Referring now to FIG. 11, there is illustrated a generalized flow chart of predicting one or more paths for a vehicle of a given class out of all paths available to the class, the vehicle having a current at least partial trajectory t, in accordance with certain embodiments. For each path p available to be taken by vehicles of the given class, processing unit (14) compares (1100) each reference trajectory r associated with p to t using a predefined distance-direction metric. The comparison is made by comparing the last data point dₗₐₛₜ point on t (being indicative of the vehicle's most current position and direction, inter alia) to the data point dᵢ on r which is closest in two-dimensional space to dₗₐₛₜ using the predefined distance-direction metric. The predefined distance-direction metric is indicative of the maximum allowable deviation in the two-dimensional distance of the two trajectories as measured from the end-point of t, and the maximum allowable deviation of the direction (i.e. θ) of the two trajectories as measured from the end point of t. If at least one reference trajectory r associated with p satisfies (1102) the distance-direction metric, the path p associated with r is determined (1104) to be a predicted path for the vehicle, and otherwise the associated path p is determined (1106) not to be a predicted path for the vehicle. By way of non-limiting example, the distance-direction metric can be, e.g. maximum deviation in distance equal to or less than 30 pixels and maximum deviation in direction equal to or less than 30 degrees.

In certain embodiments, the probability of v and w taking conflicting paths p, q can be determined as follows. First, a probability distribution is generated indicative of a probability of vehicles v and w vehicles taking a given pair of paths p, q using the matching cost calculated for the reference trajectories rᵥ, r_{w} associated with p, q, respectively. An example will now be provided. Suppose that for v there are two predicted paths p₁ and p₂ and for w there are two predicted paths q₁ and q₂. Suppose further that p₁ and q₁ are conflicting paths (at least one reference trajectory in p₁ conflicts with at least one reference trajectory in q₁). Suppose further that the matching cost for the selected reference trajectory associated with each path for each vehicle is provided in the following table:

| Vehicle | p₁ | p₂ | q₁ | q₂ |
|---|---|---|---|---|
| v | 30 | 50 | — | — |
| w | — | — | 10 | 90 |

Since a lower matching cost corresponds to a closer match, the inverse of the matching cost can be used as a similarity score indicative of the likelihood that the vehicle will take a given path. The similarity score can be used to estimate the probability P(x) of a vehicle taking a given path out of all predicted paths is provided in the following table:

| Vehicle | P(p₁) | P(p₂) | P(q₁) | P(q₂) |
|---|---|---|---|---|
| v | $\frac{1}{30} / ( \frac{1}{30} + \frac{1}{50} ) = 0.625$ | $\frac{1}{50} / ( \frac{1}{30} + \frac{1}{50} ) = 0.375$ | — | — |
| w | — | — | $\frac{1}{10} / ( \frac{1}{10} + \frac{1}{90} ) = 0.9$ | $\frac{1}{10} / ( \frac{1}{10} + \frac{1}{90} ) = 0.1$ |

The probability distribution of v and w taking a given pair of paths is provided in the table below:

| | p₁ | p₂ |
|---|---|---|
| q₁ | P(p₁& q₁) = P(p₁) × P(q₁) = | P(p₂& q₁) = P(p₂) × P(q₁) = |
| | 0.625 × 0.9 = 0.5625 | 0.375 × 0.9 = 0.3375 |
| q₂ | P(p₁& q₂) = P(p₁) × P(q₂) = | P(p₂& q₂) = P(p₂) × P(q₂) = |
| | 0.625 × 0.1 = 0.0625 | 0.375 × 0.1 = 0.0375 |

As the above table illustrates, the likelihood of v and w taking conflicting paths p₁ and q₁, respectively, is greater than the likelihood of v and w taking a different pair of paths. As the table further illustrates, the likelihood of v and w taking p₁ and q₁, respectively, is greater than 50%.

It will be appreciated by one skilled in the art that many different types of warnings can be generated, and under a variety of conditions. The warning type and conditions can be implementation dependent.

It is noted that the teachings of the presently disclosed subject matter are not bound by the collision prediction system described with reference to FIG. 1. Equivalent and/or modified functionality can be consolidated or divided in another manner and can be implemented in any appropriate combination of software with firmware and/or hardware and executed on a suitable device. The collision prediction system can be a standalone computer system, or integrated, fully or partly, with other computer systems.

It is noted that the teachings of the presently disclosed subject matter are not bound by the flow charts illustrated in FIGS. 2, 9-11 and 14; the illustrated operations can occur out of the illustrated order. For example, operations (202) and (204) can be be executed substantially concurrently or in the reverse order. It is also noted that whilst the flow chart is described with reference to elements of CPS (10), this is by no means binding, and the operations can be performed by elements other than those described herein.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A method of generating an intersection model useable for predicting traffic collisions at a given intersection between vehicles of different classes, the method implemented by a processing unit and comprising, by the processing unit:
(a) classifying a vehicle appearing in image data as belonging to a given class out of a predefined set of classes, wherein the image data is informative of a plurality of successive images of vehicles at the intersection;
(b) tracking the vehicle to extract the vehicle's trajectory and associating the extracted trajectory with the class of the vehicle;
(c) repeating operations (a)-(b) in respect of a plurality of vehicles belonging to different classes to obtain a plurality of extracted trajectories, each associated with a given class out of the predefined set of classes, until a completion criterion is satisfied;
(d) for each given class, generating a plurality of reference trajectories associated with the given class and with the given intersection using at least part of the plurality of extracted trajectories associated with the given class, and
(e) for each given class, clustering the reference trajectories into one or more clusters, each cluster informative of a path available to be taken by vehicles of the given class at the intersection.

2. The method of claim 1, further comprising generating a data structure comprising data indicative of all conflicting pairs of reference trajectories, wherein the reference trajectories in a conflicting pair are associated with different classes and wherein a given pair of reference trajectories conflict when the minimal distance between the reference trajectories in the pair is less than a predefined threshold.

3. The method of claim 2, further comprising storing, in the data structure, data informative of one or more pairs of conflicting data points for each pair of conflicting reference trajectories, each one or more pairs of conflicting data points constituted by a first conflicting data point in the first reference trajectory and a second conflicting data point in the second reference trajectory.

4. A method of determining the likelihood of a traffic collision between vehicles of different vehicle classes at an intersection, the method implemented by a processing unit and comprising:
obtaining data informative of an intersection model associated with the intersection, the intersection model comprising a plurality of reference trajectories associated with each of a plurality of predefined vehicle classes, the intersection model further comprising conflict data informative of conflicting reference trajectories associated with different classes;
classifying a first vehicle appearing in image data as belonging to a first class out of the plurality of predefined vehicle classes, and classifying a second vehicle appearing in the image data as belonging to a second class out of the plurality of predefined vehicle classes different from the first class, wherein the image data is informative of a plurality of successive images of vehicles at the intersection;
tracking the first and second vehicle using the image data to extract a first trajectory associated with the first vehicle and a second trajectory associated with the second vehicle;
selecting, from the plurality of reference trajectories comprised in the intersection model and associated with the first class, a first set of reference trajectories best matching the first trajectory, and selecting, from the plurality of reference trajectories comprised in the intersection model and associated with the second class, a second set of reference trajectories best matching the second trajectory;
identifying, using the data indicative of the intersection model, one or more pairs of conflicting reference trajectories, each pair constituted by a first reference trajectory from the first set and a conflicting second reference trajectory from the second set;
for each pair of conflicting reference trajectories, mapping the first vehicle to a data point on the first reference trajectory in accordance with the first trajectory, and mapping the second vehicle to a data point on the second reference trajectory in accordance with the second trajectory;
generating data indicative of a likelihood of a collision between the first and second vehicle in accordance, at least, with the data points to which the vehicles have been, respectively, mapped; and
generating a warning when the generated data satisfy a predetermined criterion.

5. The method of claim 4, wherein generating data indicative of a likelihood of a collision between the first and second vehicle in accordance with the data points to which the vehicles have been, respectively mapped comprises, by the processing unit:
determining, using the intersection model, a first conflicting data point on the first reference trajectory and a second conflicting data point on the second reference trajectory;
determining, in accordance with an index of the data point on the first conflicting reference trajectory to which the first vehicle has been mapped and an index number of the first conflicting data point and a frame rate of the image data, a time to arrival of the first vehicle to the first conflicting data point; and
determining, in accordance with an index of the data point on the second conflicting reference trajectory to which the second vehicle has been mapped and an index number of the second conflicting data point and a frame rate of the image data, a time to arrival of the second vehicle to the second conflicting data point.

6. The method of claim 5, wherein each reference trajectory comprised in the intersection model and associated with a given class is further associated with a given path out of one or more available paths available to be taken by vehicles of the given class through the intersection; and
wherein selecting a set of reference trajectories best matching a given vehicle's associated trajectory comprises, by the processing unit:
determining one or more predicted paths out of the one or more available paths in accordance with the given vehicle's associated trajectory;
assigning a matching cost to each reference trajectory associated with each predicted path in accordance with the given vehicle's trajectory; and
for each one or more predicted paths, selecting the reference trajectory associated with the predicted path having the lowest matching cost as between all other reference trajectories also associated with the predicted path.

7. The method of claim 6, further comprising, by the processing unit:
determining, for at least one identified pair of reference trajectories, the probability of the first vehicle taking the path p associated with the first trajectory and the second vehicle taking the path q associated with the second reference trajectory, and wherein the predetermined criterion is at least partially met when the probability of the first and second vehicle taking the pair of paths p,q, respectively, is greater than the probability of the first and second vehicles taking a different pair of paths.

8. The method of claim 7 wherein one of the first and second vehicle is a car and the other of the first and second vehicle is a bicycle.

9. A system for generating an intersection model useable for predicting traffic collisions at a given intersection between vehicles of different classes, the system comprising a processing unit including at least a processor operatively coupled to a memory, the processing unit configured to:
(a) classify a vehicle appearing in image data as belonging to a given class out of a predefined set of classes, wherein the image data is informative of a plurality of successive images of vehicles at the intersection;
(b) track the vehicle to extract the vehicle's trajectory and associating the extracted trajectory with the class of the vehicle;
(c) repeat operations (a)-(b) in respect of a plurality of vehicles belonging to different classes to obtain a plurality of extracted trajectories, each associated with a given class out of the predefined set of classes, until a completion criterion is satisfied;
(d) for each given class, generate a plurality of reference trajectories associated with the given class and with the given intersection using at least part of the plurality of extracted trajectories associated with the given class, and
(e) for each given class, cluster the reference trajectories into one or more clusters, each cluster informative of a path available to be taken by vehicles of the given class at the intersection.

10. The system of claim 9, wherein the processing unit is further configured to: generate a data structure in the memory comprising data indicative of all conflicting pairs of reference trajectories, wherein the reference trajectories in a conflicting pair are associated with different classes and wherein a given pair of reference trajectories conflict when the minimal distance between the reference trajectories in the pair is less than a predefined threshold.

11. The system of claim 10, wherein the processing unit is further configured to: store, in the data structure, data informative of one or more pairs of conflicting data points for each pair of conflicting reference trajectories, each one or more pairs of conflicting data points constituted by a first conflicting data point in the first reference trajectory and a second conflicting data point in the second reference trajectory.

12. A system for determining the likelihood of a traffic collision between vehicles of different vehicle classes at an intersection, the system comprising a processing unit including at least a processor operatively coupled to a memory, the processing unit configured to:
obtain from the memory data informative of an intersection model associated with the intersection, the intersection model comprising a plurality of reference trajectories associated with each of a plurality of predefined vehicle classes, the intersection model further comprising conflict data informative of conflicting reference trajectories associated with different classes;
classify a first vehicle appearing in image data as belonging to a first class out of the plurality of predefined vehicle classes, and classifying a second vehicle appearing in the image data as belonging to a second class out of the plurality of predefined vehicle classes different from the first class, wherein the image data is informative of a plurality of successive images of vehicles at the intersection;
track the first and second vehicle using the image data to extract a first trajectory associated with the first vehicle and a second trajectory associated with the second vehicle;
select, from the plurality of reference trajectories comprised in the intersection model and associated with the first class, a first set of reference trajectories best matching the first trajectory, and select, from the plurality of reference trajectories comprised in the intersection model and associated with the second class, a second set of reference trajectories best matching the second trajectory;
identify, using the data indicative of the intersection model, one or more pairs of conflicting reference trajectories, each pair constituted by a first reference trajectory from the first set and a conflicting second reference trajectory from the second set;
for each pair of conflicting reference trajectories, map the first vehicle to a data point on the first reference trajectory in accordance with the first trajectory, and map the second vehicle to a data point on the second reference trajectory in accordance with the second trajectory;
generate data indicative of a likelihood of a collision between the first and second vehicle in accordance, at least, with the data points to which the vehicles have been, respectively, mapped; and
generate a warning when the generated data satisfy a predetermined criterion.

13. The system of claim 12, wherein the processing unit configured to generate data indicative of a likelihood of a collision between the first and second vehicle in accordance with the data points to which the vehicles have been, respectively mapped comprises, the processing unit configured to:
determine, using the intersection model, a first conflicting data point on the first reference trajectory and a second conflicting data point on the second reference trajectory;
determine, in accordance with an index of the data point on the first conflicting reference trajectory to which the first vehicle has been mapped and an index number of the first conflicting data point and a frame rate of the image data, a time to arrival of the first vehicle to the first conflicting data point; and
determine, in accordance with an index of the data point on the second conflicting reference trajectory to which the second vehicle has been mapped and an index number of the second conflicting data point and a frame rate of the image data, a time to arrival of the second vehicle to the second conflicting data point.

14. The system of claim 13,
wherein each reference trajectory comprised in the intersection model and associated with a given class is further associated with a given path out of one or more available paths available to be taken by vehicles of the given class through the intersection; and
wherein the processing unit configured to select a set of reference trajectories best matching a given vehicle's associated trajectory comprises the processing unit configured to:
determine one or more predicted paths out of the one or more available paths in accordance with the given vehicle's associated trajectory;
assign a matching cost to each reference trajectory associated with each predicted path in accordance with the given vehicle's trajectory; and
for each one or more predicted paths, select the reference trajectory associated with the predicted path having the lowest matching cost as between all other reference trajectories also associated with the predicted path.

15. The system of claim 14, wherein the processing unit is configured to:
determine, for at least one identified pair of reference trajectories, the probability of the first vehicle taking the path p associated with the first trajectory and the second vehicle taking the path q associated with the second reference trajectory, and wherein the predetermined criterion is at least partially met when the probability of the first and second vehicle taking the pair of paths p,q, respectively, is greater than the probability of the first and second vehicles taking a different pair of paths.

16. The system of claim 15 wherein one of the first and second vehicle is a car and the other of the first and second vehicle is a bicycle.

17. A non-transitory storage medium comprising instructions that when executed by a processing unit comprising at least a processor operatively coupled to a memory, cause the processing unit to:
obtain data informative of an intersection model associated with the intersection, the intersection model comprising a plurality of reference trajectories associated with each of a plurality of predefined vehicle classes, the intersection model further comprising conflict data informative of conflicting reference trajectories associated with different classes;
classify a first vehicle appearing in image data as belonging to a first class out of the plurality of predefined vehicle classes, and classifying a second vehicle appearing in the image data as belonging to a second class out of the plurality of predefined vehicle classes different from the first class, wherein the image data is informative of a plurality of successive images of vehicles at the intersection;
track the first and second vehicle using the image data to extract a first trajectory associated with the first vehicle and a second trajectory associated with the second vehicle;
select, from the plurality of reference trajectories comprised in the intersection model and associated with the first class, a first set of reference trajectories best matching the first trajectory, and select, from the plurality of reference trajectories comprised in the intersection model and associated with the second class, a second set of reference trajectories best matching the second trajectory;
identify, using the data indicative of the intersection model, one or more pairs of conflicting reference trajectories, each pair constituted by a first reference trajectory from the first set and a conflicting second reference trajectory from the second set;
for each pair of conflicting reference trajectories, map the first vehicle to a data point on the first reference trajectory in accordance with the first trajectory, and map the second vehicle to a data point on the second reference trajectory in accordance with the second trajectory;
generate data indicative of a likelihood of a collision between the first and second vehicle in accordance, at least, with the data points to which the vehicles have been, respectively, mapped; and
generate a warning when the generated data satisfy a predetermined criterion.

18. The medium of claim 17, further comprising instructions that cause the processing unit to:
determine, using the intersection model, a first conflicting data point on the first reference trajectory and a second conflicting data point on the second reference trajectory;
determine, in accordance with an index of the data point on the first conflicting reference trajectory to which the first vehicle has been mapped and an index number of the first conflicting data point and a frame rate of the image data, a time to arrival of the first vehicle to the first conflicting data point; and
determine, in accordance with an index of the data point on the second conflicting reference trajectory to which the second vehicle has been mapped and an index number of the second conflicting data point and a frame rate of the image data, a time to arrival of the second vehicle to the second conflicting data point.

19. The medium of claim 18,
wherein each reference trajectory comprised in the intersection model and associated with a given class is further associated with a given path out of one or more available paths available to be taken by vehicles of the given class through the intersection; and
wherein the processing unit configured to select a set of reference trajectories best matching a given vehicle's associated trajectory comprises the processing unit configured to:
determine one or more predicted paths out of the one or more available paths in accordance with the given vehicle's associated trajectory;
assign a matching cost to each reference trajectory associated with each predicted path in accordance with the given vehicle's trajectory; and
for each one or more predicted paths, select the reference trajectory associated with the predicted path having the lowest matching cost as between all other reference trajectories also associated with the predicted path.

20. The medium of claim 19, further comprising instructions that cause the processing unit to:
determine, for at least one identified pair of reference trajectories, the probability of the first vehicle taking the path p associated with the first trajectory and the second vehicle taking the path q associated with the second reference trajectory, and wherein the predetermined criterion is at least partially met when the probability of the first and second vehicle taking the pair of paths p,q, respectively, is greater than the probability of the first and second vehicles taking a different pair of paths.
